(19) United States
(12) Patent Application Publication
(10) Pub. No.: US 2007/0042694 A1
(43) Pub. Date: Feb. 22, 2007

(54) Modified-atmosphere preservation of live bivalve shellfish in a hermetic container

(76) Inventors: Laura Pastoriza Enriquez, Vigo (ES); Gabriel Sampedro Cedeira, Vigo (ES); Marta Bernardez Costas, Vigo (ES); Marta Lopez Cabo, Vigo (ES); Juan J. Rodriguez Herrera, Vigo (ES)

Correspondence Address: KLAUBER & JACKSON, 4TH FLOOR, 411 HACKENSACK AVE., HACKENSACK, NJ, 07601, US

(21) Appl. No.: 11/398,355

(22) Filed: Apr. 5, 2006

Related U.S. Application Data
(63) Continuation of application No. PCT/ES04/70071, filed on Sep. 21, 2004.

(30) Foreign Application Priority Data
Oct. 6, 2003 (ES) 200302313

(51) Int. Cl. A22C 29/04

(52) U.S. Cl. 452/12

(57) ABSTRACT

The invention relates to a method of preserving shellfish using a modified atmosphere which is rich in oxygen and which contains a second main nitrogen component, such as to preserve the live bivalve shellfish and safeguard the quality of said food for as long as possible throughout the marketing and sales process. The shellfish sales packaging must be full and well compacted, for which purpose, the units must be perfectly inserted during the filling operation using a vibrator, such that the bivalve shellfish cannot open their valves and lose intervalvular liquid throughout the sales process. The invention relates to the most popular bivalve on the market in terms of sales and price and, as a result, is of particular interest to the mussel industry.

### RELATED APPLICATIONS

The present application is a Continuation of co-pending PCT Application No. PCT/ES2004/070071, filed Sep. 21, 2004 which in turn, claims priority from Spanish Application Serial No. 200302313, filed on Oct. 6, 2003. Applicants claim the benefits of 35 U.S.C. §120 as to the PCT application and priority under 35 U.S.C. §119 as to said Spanish application, and the entire disclosures of both applications are incorporated herein by reference in their entireties.

### FIELD OF THE INVENTION

The invention that is claimed comes within the food sector and more specifically the production and distribution of live shellfish for marketing.

### BACKGROUND OF THE INVENTION

MAP (modified-atmosphere packaging) technology is being used in the conservation of a wide range of fresh and refrigerated foods, including raw and cooked meats, fish, fresh pasta, fruit and vegetables, and recently coffee, tea and beers. It is a technology that is being applied in the food sector for the packaging of refrigerated products having a limited shelf life and its success is due above all to its effectiveness against the main microbial flora that can be present by chance in food (Stammen K, Gerdes D, Caporaso, F. 1990, Modified atmosphere packaging of seafood. Crit. Rev. Food Sci. Nutr. 29:301-331; Devlieghere F, Debevere J. 2000. Influence of dissolved carbon dioxide on the growth of spoilage bacteria. Lebensm. Wiss. Technol. 33:531-537; Cutter C N, 2002. Microbial control by packaging: a review. Crit Rev Food Sci Nutr 42:151-161). The advantages and disadvantages of using the MAP technique have been periodically reviewed (Farber J M. 1991. Microbiological aspects of modified-atmosphere packaging. A review. J. Food Protect. 54:58-70; Parry R T. 1993. In: Principles and Applications of Modified Atmosphere Packaging of Food. Parry R T, editor. Glasgow, UK, Blackie. P 1-18; Davies A R. 1995. Advances in Modified-atmosphere packaging. In: Gould G W, editor. New Methods of Food Preservation. Glasgow, UK: Blackie. P 304-320; Church J J, Parsons A L. 1995. Modified atmosphere packaging technology: A review. J. Sci. Food Agric. 67:14-152.; Philips C A. 1996. Review: Modified Atmosphere Packaging and its effects on the microbiological quality and safety of produce. Int J Sci Technol 31:463-479), and many studies have been conducted on all kinds of foods, both fresh (Pastoriza L, Sampedro G, Herrera J R, Cabo M L. 1996. Effect of modified atmosphere packaging on shelf-life of iced fresh hake slices. J. Sci. Food Agric. 71:541-6547; Dalgaard P. García Muñoz L, Mejlholm O. 1998. Specific inhibition of Photobacterium phosphoreum extends the shelf life of modified-atmosphere-packed cod fillets. J. Food Protect. 61:1191-1194) or defrosted (Emborg J, Laursen B G, Rathjen T, Dalgaard P. 2002. Microbial spoilage and formation of biogenic amines in fresh and thawed modified atmosphere packed salmon (Salmo salar) at 2° C. J. Appl. Microbiol. 92:790-799), and also cooked, pre-cooked, prepared dishes, etc. (Cabo M L, Pastoriza L, Bernárdez M, Herrera J R. 2001. Effectiveness of CO₂ and nisin to increase shelf life of fresh pizza. Food Microbiol. 18:489-498; Pastoriza L, Cabo M L, Bernárdez M, Sampedro G, Herrera J R. 2002. Combined effects of MAP and lauric acid on stability of refrigerated pre-cooked fish products. EUR Food Res. Technol. 215:189-193), for achieving greater stabilisation of the quality during marketing. Nevertheless, there is still a very low degree of knowledge when it comes to the application of this technique in the stabilisation of live shellfish, which would likewise permit a packaged product to be offered with a shelf life longer than that at which products are currently marketed. In these cases, the gas composition is different, and in the end it concerns a product that is still alive, and so it is therefore necessary to create an ambience in which the bivalve can survive. Studies by Coleman (Coleman, 1973. The oxygen consumption of Mytilus edulis in air. Com. Biochem. Physiol. 45:392-402), Widdows et al. (1979), Shick J M, Gnaiger E, Widdows J, Bayne B L, de Zwaan. 1986. Activity and metabolism in the mussel Mytilus edulis 1. During intertidal hypoxia and aerobic recovery. Physiol. Zool. 59:627-642) confirmed that bivalves out of water maintain their metabolism at the expense of using atmospheric oxygen. Also, the intervalvular sea-water that they maintain between their shells permits them to live by changing their metabolism.

The mussel industry is not a very innovative sector when it comes to methods or techniques used in the marketing of live mussels. It currently continues to use techniques very similar to those used in the past, consisting solely of extracting the mussels in the culture plot, declumping them, cleaning them, sometimes debyssing, surface cleaning of the valves and packaging. The greatest differences are on account of mechanisation in some of the stages of the process taking the place of manual work, for example brushing and/or debyssing can be cited. It is a technology which continues to be fairly artisanal.

The presentations normally used in packaging live mussels for marketing consist of mesh bags of 1, 2, 5, 10, 15, 25 and 50 kg, wooden boxes of 2 and 5 kg, and plastic boxes of 5 kg. Even though they are used, none of these packagings are sufficiently practical and they need to be improved. The greatest disadvantages shown by mesh bags is the inconvenience and lack of hygiene implied by continual drainage coming from the intervalvular liquid of the shellfish. Similar problems are shown by wooden boxes, since they are not hermetic, as well as being too heavy, which does not make for easy handling during the marketing and sale stages. In the case of bags, the drainage problem has sought to be solved by introducing them into cardboard boxes at the moment of distribution. Plastic boxes, being totally sealed containers, do not occasion the inconveniences of dripping, but the shellfish are in contact with air, which is not the most suitable ambience for keeping the bivalve alive once it is out of its natural habitat.

In relation to the small sealed and impermeable packaging, a German company Roem van Yerseke, markets and exports live mussels in polystyrene containers. At the moment of sealing the container, a considerable amount of interior air is eliminated by creating a partial vacuum in the actual packaging machine.

The results are considered to be of enormous interest for the mussel industry of Galicia since it concerns the most popular bivalve on the Spanish market, on account of its volume of sales and its price. It is also much appreciated, not just because of the excellent quality of its flesh but also because of its size and the very important levels reached by its production (approximately 262,000 tons/year, representing 45% of world production), which turns it into an important raw material on both the domestic and the international markets.

### BRIEF DESCRIPTION OF THE INVENTION

The invention relates to a method of preserving live bivalve shellfish based on the use of a modified atmosphere rich in a composition of oxygen, with a second component, nitrogen, with the aim of maintaining the bivalve shellfish alive for their marketing, safeguarding the quality of that food for as long as possible throughout the marketing and sales process.

The most suitable concentrations corresponding to a particular embodiment of this invention for mussels are approximately 80% oxygen and 20% nitrogen, in concentration.

The shellfish sales packaging must be full and well compacted, for which purpose the units must be perfectly inserted during the filling operation using a vibrator, such that throughout the sales process the bivalve shellfish do not have the opportunity of opening their valves and losing the intervalvular liquid. A refrigerated sea-water bath is used for submerging the bivalves in the stage following the debyssing with the aim of stabilising the shellfish.

### DETAILED DESCRIPTION OF THE INVENTION

In order to increase the range of presentations of fresh shellfish on the market, this patent was aimed at creating an atmosphere different from air and better suited for permitting the mussel to stay alive, hermetically packed and maintaining a natural and fresh appearance, guaranteeing its quality for a period of time greater than that of standard treatment (air), in the refrigerated state and under optimum conditions for being marketed. As this concerns a live product, interest was focused on achieving stability and increasing its period of life, maintaining the response capacity and the sensorial qualities that the consumer demands.

The authors of this patent demonstrate greater survival for the bivalves during marketing, achieving compositions of gas mixtures which favour respiration and are less injurious for the bivalves than others containing CO₂ which are typical of other packaged foods. The fact that the intervalvular metabolism of any bivalve excretes CO₂ gas among other substances would cause the concentration of this gas to increase in a sealed container where this component had previously been introduced, with toxic levels being able to be reached for the live organism. The authors have already observed that the presence of carbon dioxide in the initial gaseous composition favours the mortality of shellfish (values unpublished). Operations prior to packaging are also included.

This novel system starts from the conventional system of the typical processing of fresh marketable bivalve shellfish (extraction of the mussel in the culture park, declumping, cleaning, sometimes debyssing, surface cleaning of the valves and packaging) though novel suitable stages and systems are introduced and claimed for achieving greater survival of this organism. It includes:

a) A refrigerated sea-water immersion bath following the debyssing so that the shellfish, which was stressed and injured during the debyssing operation, can recover in a short space of time.

b) The following stage that is included is that of filling of the product in plastic containers. The filling with bivalves will be done so as to take up the entire volume of the interior of the plastic container.

c) The accommodation that then follows is done by a vibrator in contact with the bottom of the container, and a level of filling must be achieved that is no less than the height corresponding to the closure of the container so that the bivalves do not have the opportunity of being able to open their valves and lose the intervalvular liquid.

d) The system of filling with modified atmospheres and sealing is done immediately afterwards.

The mixture of gases that has to remain inside the sealed container must contain approximately 80% of oxygen and 20% of nitrogen. The provision of the gas is done with a predetermined mixture (O₂/N₂; 80%/20%), or by oxygen (100% concentration) both marketed. In the latter case the 20% composition that would correspond to nitrogen is provided by means of air being added by the filling equipment so that the interior composition can be approximately 80% O₂ and 20% N₂ as is intended. The sealing, which is done by the same equipment and for filling with atmosphere, has to be hermetic. The plastic sealing film will tighten the content of bivalves preventing them from moving.

The following phases are the usual ones in the marketing of these products, though the results, survival to 6 days, are subject to the temperature being kept at 0-3° C.

Advantages in Relation to the Conventional Art or Others

It improves the presentation of the bivalves, it minimises spillages of intervalvular water due to the fact that the shells remain closed by the pressure exerted among the units.

The high concentration of oxygen does not alter the product as in the case of containers with dead food. The dissolution of the oxygen in the intervalvular liquid is favoured by applying lower refrigeration temperatures (0-3° C.). The uptake of oxygen by the living organism is more efficient.

The evident mortality of organisms adhered to the outside surface of the shells (barnacles, tubiforms, etc.) is slower than in the case of bivalves marketed in contact with air, or with gas mixtures containing CO₂ (which are toxic for living organisms) at ambient temperatures or unsuitable refrigeration temperatures. The effect of the death of these small accompanying organisms is the production of undesirable odours, especially in sealed containers.

The quality of the product is improved in relation to the conventional art given equal storage times. The greater survival rate extends the marketing network further. There is a reduction in rejects owing to dead shellfish.

### EXAMPLES

### Example 1

### Processing of Mussels in a Protective Atmosphere Applying a Commercial Gas Mixture

After keeping the shellfish in cleaning pools for 48 hours, they will be mechanically debyssed by equipment known in the industry. A surface cleaning of the shells will be carried out in order to remove the majority of organisms stuck to the surface.

The shellfish is introduced into tanks of refrigerated sea-water (6° C.) by means of a hoist containing perforated baskets which submerge the bivalve for up to 6 minutes.

A grader selects batches of units weighing around 1 kg, and units that are broken or show signs of mortality will be discarded. These batches are introduced into rectangular containers made of a barrier plastic material of the PE-HD type of dimensions 264×165×51 cm, for example.

The operation of filling the atmosphere can take place by coupling a bottle to the machine, the bottle being supplied by a gas supplier firm and having a volumetric composition of O₂/N₂; 80%/20%. The machine itself will proceed to seal the container with a barrier film of the GPO1570 type, for example. The process is cheap and, in a short period of time, the living organism is subjected to high vacuum conditions.

The immediate quality control consists of checking the airtightness of the seal. The container must not be swollen, and the pressure inside must be atmospheric. The sealing of the container is checked by submerging it in water and making sure that no bubbles appear.

Shellfish that are broken, defects in the seal and cuts in the film produced by the sharp edges of the bivalve are all cause for rejection.

### Example 2

### Processing of Mussels in a Protective Atmosphere Applying Pure Commercial Gases with in Situ Mixing

All steps described in example 1 will be performed except that pure commercial gases are applied, which are mixed in situ by means of the corresponding flowmeters indicating the quantity of each gas; an expansion chamber can be inserted in the line in order to ensure homogenous mixing at the moment of packaging, or the gases can be applied directly and mixed in the container. The flow of oxygen is four times greater than that of nitrogen in order to achieve the composition O₂/N₂; 80%/20%.

### Example 3

### Processing of Mussels in a Protective Atmosphere Applying just Oxygen

All the steps described in example 1 will be performed except in the filling which will be more economical due to using just one gas coming from a bottle containing 100% oxygen. The handling of the filling system for the machine can achieve less evacuation of air in the system by producing a partial vacuum in order to achieve mixtures with a composition of 80% oxygen and 20% air (the composition of which is mostly nitrogen). Fine adjustment of this system requires precise control of the sealing machine and previous testing with regard to the arrangement of the controls for the equipment and also checking of the composition of the filling gas in empty containers. Suitable, easy to handle, equipment for determining gas compositions can be acquired from Spanish companies.

### BRIEF DESCRIPTION OF THE FIGURES

FIG. 1 shows mussel processing in diagrammatic form. The conventional line starts with the extraction of the mollusc and ends in the debyssing for being bagged. We include a stabilisation stage for the live organism, application of atmospheres, sealing and marketing in a cold environment.

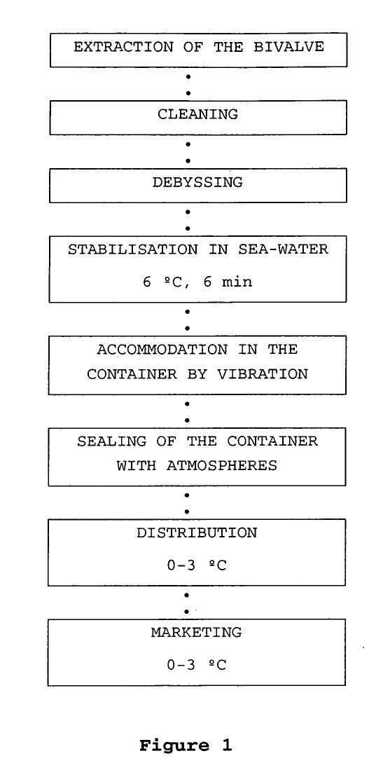

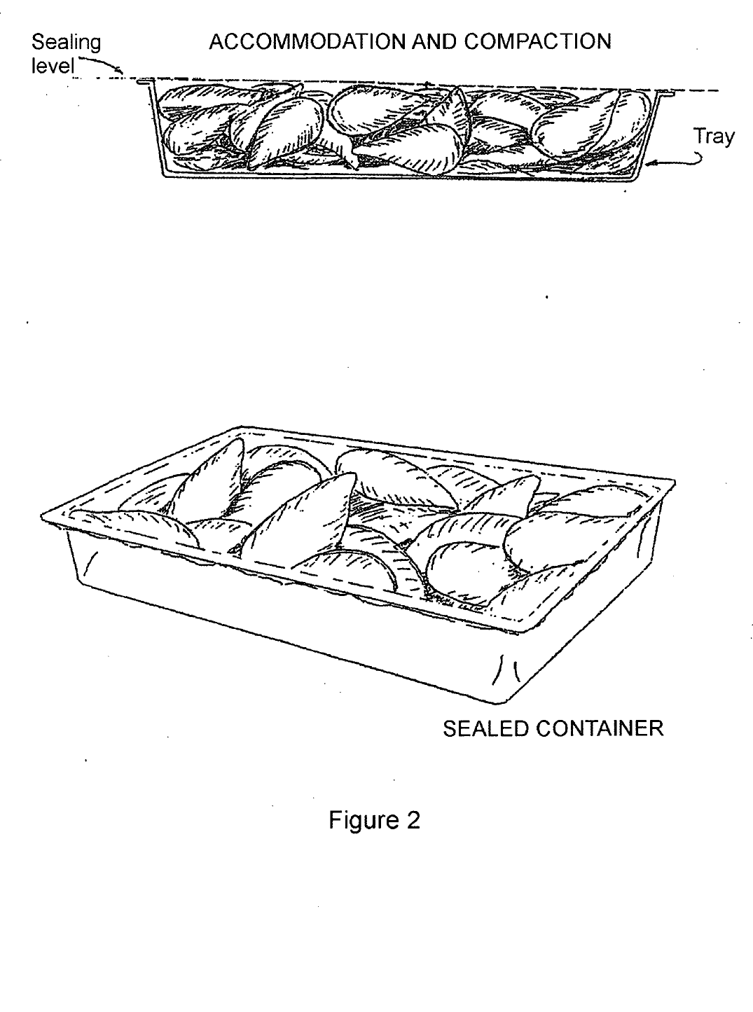

Notable in FIG. 2 is the arrangement of the shellfish after they have been accommodated and compacted. The line of the level of the tray sealing indicates the filling height of the bivalve. The external appearance of a sealed container can also be seen.

While the invention has been described and illustrated herein by references to the specific embodiments, various specific materials, procedures and examples, it is understood that the invention is not restricted to the particular materials, combinations of materials, and procedures selected for that purpose. Indeed, various modifications of the invention in addition to those described herein will become apparent to those skilled in the art from the foregoing description and the accompanying figures. Such modifications are intended to fall within the scope of the appended claims.

1. Method of preserving live bivalve shellfish using modified atmospheres in a hermetic container, characterised by comprising the following stages:
cleaning, debyssing and stabilisation in the case of mussels
filling of the container
optionally, compaction could be carried out
application of modified atmospheres containing at least 50% oxygen and without the addition of CO₂
sealing at atmospheric pressure
refrigeration at below 15° C. (preferably between 0 and 3° C.)

2. Method of preserving live bivalve shellfish using modified atmospheres in a hermetic container in accordance with claim 1, characterised in that the stabilisation process of the shellfish consists of a bath of clean sea-water at low temperatures, preferably at 6° C., for 6 minutes.

3. Method of preserving live bivalve shellfish using modified atmospheres in a hermetic container in accordance with claim 1, characterised in that the application of the modified atmosphere with which the container is filled consists of applying a concentration of oxygen of between 50 and 90% with the rest being mostly nitrogen whether by means of a commercial mixture or a mixture in situ, preferably 80% oxygen and 20% nitrogen.

4. Method of preserving live bivalve shellfish using modified atmospheres in a hermetic container in accordance with claim 1, characterised in that the application of the modified atmosphere with which the container is filled consists of applying 100% O₂ and air up to achieving a mixture of gases having a concentration of oxygen of between 50 and 90%, preferably 75-80% oxygen.

5. Method of preserving live bivalve shellfish using modified atmospheres in a hermetic container in accordance with claim 1, characterised in that the application of the modified atmosphere with which the container is filled consists of applying 100% O₂, previously applying a light vacuum with which, with the remnant air, a mixture of gases is achieved having a concentration of oxygen of between 50 and 90%, preferably 75-80% of O₂.

6. Method of preserving live bivalve shellfish using modified atmospheres in a hermetic container in accordance with claim 2, characterised in that the application of the modified atmosphere with which the container is filled consists of applying a concentration of oxygen of between 50 and 90% with the rest being mostly nitrogen whether by means of a commercial mixture or a mixture in situ, preferably 80% oxygen and 20% nitrogen.

7. Method of preserving live bivalve shellfish using modified atmospheres in a hermetic container in accordance with claim 2, characterised in that the application of the modified atmosphere with which the container is filled consists of applying 100% O₂ and air up to achieving a mixture of gases having a concentration of oxygen of between 50 and 90%, preferably 75-80% oxygen.

8. Method of preserving live bivalve shellfish using modified atmospheres in a hermetic container in accordance with claim 2, characterised in that the application of the modified atmosphere with which the container is filled consists of applying 100% O₂, previously applying a light vacuum with which, with the remnant air, a mixture of gases is achieved having a concentration of oxygen of between 50 and 90%, preferably 75-80% of O₂.
